(19) United States
(12) Patent Application Publication
(10) Pub. No.: US 2026/0241627 A1
(43) Pub. Date: Aug. 20, 2026

(54) NOZZLE DESIGN AND TEMPERATURE-CONTROLLED DISPENSE MECHANISM FOR 1K POLYURETHANE ADHESIVES

(71) Applicant: GM Global Technology Operations LLC, Detroit, MI (US)

(72) Inventors: Varun Chandra Kalur, West Bloomfield, MI (US); Jared C. Harper, Lake Orion, MI (US)

(21) Appl. No.: 19/058,243

(22) Filed: Feb. 20, 2025

(51) Int. Cl. B29C 48/00; B29C 48/793; B29K 75/00; B29K 105/00

(52) U.S. Cl. CPC B29C 48/0014; B29C 48/793; B29C 2948/92219; B29C 2948/92333; B29C 2948/92561; B29C 2948/92704; B29K 2075/00; B29K 2105/0097

(57) ABSTRACT

A method of forming an adhesive layer, the method comprising: providing a blocked isocyanate component and a polyol component; introducing the blocked isocyanate component and the polyol component into a first end of a heated chamber; heating the heated chamber at a temperature and for a time that are sufficient to de-block the blocked isocyanate component to form a deblocked isocyanate component; extruding the deblocked isocyanate component and the polyol component out of a second end of the heated chamber and into a dispenser nozzle; and dispensing the deblocked isocyanate component and the polyol component from the dispenser nozzle to form an adhesive layer, wherein an amount of de-blocking of the blocked isocyanate component is determined in the heated chamber using a first detection probe located adjacent to the first end of the heated chamber and a second detection probe located adjacent to the second end of the heated chamber.

### INTRODUCTION

The subject disclosure relates to battery cell technologies, and particularly to thermal adhesives, and optionally for structural adhesives, for electrochemical cells for use in an electric vehicle.

High voltage electrical systems are increasingly used to power the onboard functions of both mobile and stationary systems. For example, in motor vehicles, the demand to increase fuel economy and reduce emissions has led to the development of advanced electric vehicles (EVs). EVs rely upon Rechargeable Energy Storage Systems (RESS), which typically include one or more high voltage battery packs, and an electric drivetrain to deliver power from the battery to the wheels. Battery packs can include any number of interconnected battery modules depending on the power needs of a given application. Each battery module includes a collection of conductively coupled electrochemical cells. The battery pack is configured to provide a Direct Current (DC) output voltage at a level suitable for powering a coupled electrical and/or mechanical load (e.g., an electric motor).

Battery cells include an anode, a cathode, an electrolyte composition, and optionally a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. These charge and discharge cycles, particularly during vehicle operation, generate heat due to internal resistance and electrochemical reactions within the cells. Effective thermal management is critical to dissipate heat and maintain the safety and performance of the battery system. In vehicles utilizing electrical energy to provide motive force, battery cells of the vehicle may be charged, and then the vehicle may navigate for a period of time, utilizing the stored electrical energy to generate motive force.

There remains a continuing need for adhesives that are suitable for use in electric vehicle structural and battery thermal interface applications.

### SUMMARY

An aspect provides a method of forming an adhesive layer. The method includes providing a blocked isocyanate component and a polyol component. The blocked isocyanate component and the polyol component are then introduced into a first end of a heated chamber. The heated chamber is heated at a temperature and for a time that are sufficient to de-block the blocked isocyanate component to form a deblocked isocyanate component. The deblocked isocyanate component and the polyol component are extruded out of a second end of the heated chamber and into a dispenser nozzle. The deblocked isocyanate component and the polyol component are dispensed from the dispenser nozzle to form an adhesive layer. An amount of de-blocking of the blocked isocyanate component is determined in the heated chamber using a first detection probe located adjacent to the first end of the heated chamber and a second detection probe located adjacent to the second end of the heated chamber.

In an embodiment of the method, the heated chamber is heated at a temperature of 60° C. to 200° C.

In an embodiments of the method, the heated chamber is heated for a time of 5 minutes to 4 hours.

In an embodiment of the method, the first detection probe is a Fourier transform infrared spectrometer probe.

In an embodiment of the method, the second detection probe is a Fourier transform infrared spectrometer probe.

In an embodiment of the method, the adhesive layer does not comprise a foam.

In an embodiment of the method, the adhesive layer does not comprise a blowing agent.

In an embodiment of the method, the adhesive layer does not comprise a propellant.

In an embodiment of the method, the heated chamber is heated in a uniform manner.

In an embodiment of the method, a temperature of the dispenser nozzle is less than or equal to the temperature of the heated chamber.

Another aspect provides an adhesive dispensing system. The adhesive dispensing system includes a blocked isocyanate component and a polyol component disposed in a heated chamber. A heating element is configured to heat the heated chamber at a temperature and for a time that are sufficient to de-block the blocked isocyante component and to form a deblocked isocyanate component. The adhesive dispensing system also includes a dispenser nozzle for receiving the deblocked isocyanate component and the polyol component from the heated chamber, wherein the dispenser nozzle is configured to dispense the deblocked isocyanate component and the polyol component. An amount of de-blocking of the blocked isocyanate component is determined in the heated chamber using a first detection probe located adjacent to a first end of the heated chamber and a second detection probe located adjacent to a second end of the heated chamber.

In an embodiment of the adhesive dispensing system, the heated chamber is heated at a temperature of 60° C. to 200° C.

In an embodiment of the adhesive dispensing system, the heated chamber is heated for a time of 5 minutes to 4 hours.

In an embodiment of the adhesive dispensing system, the first detection probe is a Fourier transform infrared spectrometer probe.

In an embodiment of the adhesive dispensing system, the second detection probe is a Fourier transform infrared spectrometer probe.

In an embodiment of the adhesive dispensing system, the adhesive dispensing system does not comprise a foam component.

In an embodiment of the adhesive dispensing system, the adhesive dispensing system does not comprise a blowing agent.

In an embodiment of the adhesive dispensing system, the adhesive dispensing system does not comprise a propellant.

In an embodiment of the adhesive dispensing system, the heated chamber is heated in a uniform manner.

In an embodiment of the adhesive dispensing system, a temperature of the dispenser nozzle is less than or equal to the temperature of the heated chamber.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a vehicle configured in accordance with one or more embodiments;

FIG. 2 is an adhesive dispensing system according to one or more embodiments; and

FIG. 3 illustrates a flowchart of an illustrative method according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

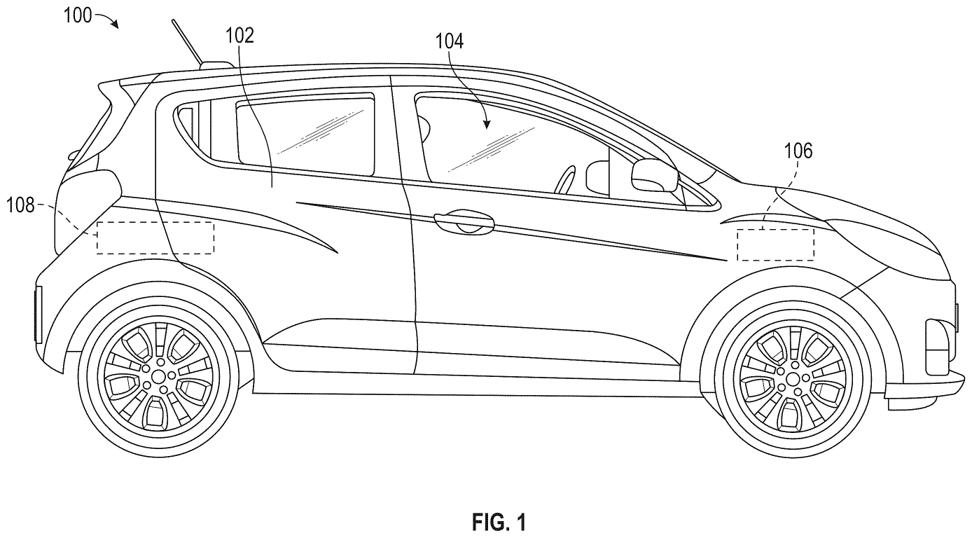

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100, although other locations are expressly contemplated but not shown). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

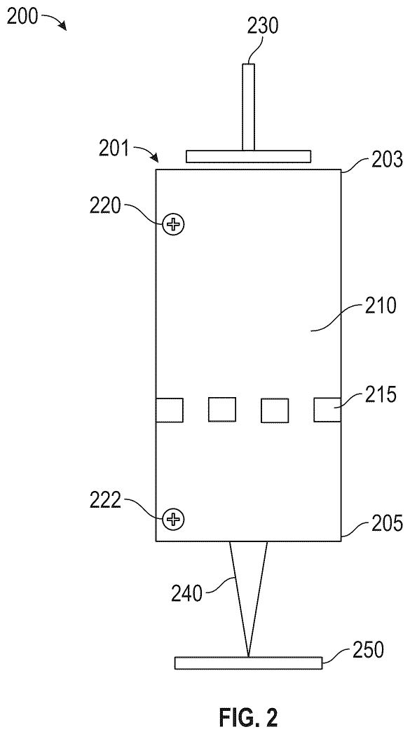

As discussed previously, various components of the battery pack 108 are attached or connected to each other using an adhesive that is suitable for use in thermal interface applications. In accordance with an exemplary embodiment disclosed is a method of forming an adhesive layer using an adhesive dispensing system. Referring to FIG. 2, an adhesive dispensing system 200 is provided.

The method includes providing a blocked isocyanate component and a polyol component. For example, the blocked isocyanate component and the polyol component may be held in a reservoir 201 until being introduced into the first end 203 of a heated chamber 210. The heated chamber 210 is then heated at a temperature and for a time that are sufficient to de-block the isocyante component to form a deblocked isocyanate component.

The heated chamber 210 may be heated at any suitable temperature to affect the de-blocking of the blocked isocyanate component. For example, in some embodiments, the heated chamber 210 may be heated at a temperature of 60° C. to 200° C., from 60° C. to 180° C., from 60° C. to 160° C., or from 60° C. to 150° C. In other embodiments, the heated chamber 210 may be heated at a temperature of 70° C. to 200° C., from 80° C. to 200° C., or from 100° C. to 200° C.

The heated chamber 210 may be heated for any suitable amount of time to effect the de-blocking of the blocked isocyanate component. For example, in some embodiments, the heated chamber 210 may be heated for a time of 5 minutes to 4 hours, from 10 minutes to 4 hours, from 15 minutes to 4 hours, or from 20 minutes to 4 hours. In other embodiments, the heated chamber 210 may be heated for a time of 5 minutes to 3 hours, from 5 minutes to 2 hours, or from 1 hour to 2 hours.

The heated chamber 210 may be of any suitable size and design. The heated chamber 210 may have a length, which extends from the first end 203 to the second end 205, that is sufficient to allow for the deblocking of the blocked isocyanate component.

The heated chamber 210 may be connected to a plunger 230 for moving the components through the heated chamber 210, into the dispenser nozzle 240, and ultimately onto the substrate 250. Any suitable plunger 230 may be used to advance the components through the dispenser system.

The heating of the heated chamber 210 may be done using any suitable method. In some embodiments, the heated chamber is heated in a uniform manner.

The deblocked isocyanate component and the polyol component are then extruded out of the second end 205 of the heated chamber 210 and into a dispenser nozzle 240. The deblocked isocyanate component and the polyol component, and any reaction products thereof, are then dispensed from the dispenser nozzle 240 onto a substrate 250 to form an adhesive layer. The temperature of the dispenser nozzle 240 may be less than or equal to a temperature of the heated chamber 210.

The extent of deblocking of the blocked isocyanate component is determined in-situ using detection probes. The amount of the de-blocking of the blocked isocyanate component is determined in the heated chamber 210 using a first detection probe 220 that is located adjacent to the first end 203 of the heated chamber 210. The amount of de-blocking of the blocked isocyanate component is also determined in the heated chamber 210 using a second detection probe 222 that is located adjacent to the second end 205 of the heated chamber 210. Any suitable detection probe may be used, as described hereinbelow. The extent of de-blocking may be assessed in two locations to ascertain whether sufficient deblocking of the blocked isocyanate component has occurred. When there is insufficient deblocking, the dwell time and/or the heating temperature may be adjusted accordingly to obtain sufficient de-blocking in the heated chamber 210.

In some embodiments, the first detection probe 220 may be a Fourier transform infrared spectrometer probe. In some embodiments, the first detection probe 220 may further include a temperature sensor. The first detection probe 220 is configured to determine the extent of free (unblocked) isocyanate groups in the blocked isocyanate component.

In some embodiments, the second detection probe 222 may be a Fourier transform infrared spectrometer probe. In some embodiments, the second detection probe 222 may further include a temperature sensor. The second detection probe 222 is configured to determine the extent of free (unblocked) isocyanate groups in the blocked isocyanate component.

In some embodiments, the mixture that includes the blocked isocyanate component and the polyol component does not further include a foam or a foaming agent. In some embodiments, the mixture that includes the blocked isocyanate component and the polyol component does not further include a blowing agent. In some embodiments, the mixture that includes the blocked isocyanate component and the polyol component does not further include a propellant. That is, in some embodiments, the resulting adhesive layer does not include a foam, a blowing agent, a propellant, or a combination thereof.

The present single component system, or 1K polyurethane system, includes a blocked isocyanate in which the NCO groups are reacted with a blocking agent that prevents the reaction with the polyol. Application of heat decomposes the blocking agent to liberate the free NCO which is then free to react. An isocyanate, which is typically considered a polyisocyanate, has the structure R—(N═C═O)ₙ, where n is at least 2, at least 3, at least 4, at least 5, at least 6, at least 7, or at least 8, and where R is an aliphatic and/or cyclic group. In one embodiment, an isocyanate has an n that is equivalent to n in methylene diphenyl diisocyanate (MDI). In one embodiment, the isocyanate is a di-isocyanate (R—(N═C═O)₂ or (O═C═N)—R—(N═C═O)).

The blocked isocyanate component may be aromatic, aliphatic, (cyclo)aliphatic, and/or cycloaliphatic polyisocyanate component. Exemplary isocyanates include, but are not limited to, aromatic diisocyanates, such as a mixture of 2,4-and 2,6-tolylene diisocyanates (TDI), diphenylmethane-4,4′-diisocyanate (MDI), naphthalene-1,5-diisocyanate (NDI), 3,3′-dimethyl-4,4′-biphenylene diisocyanate (TODI), crude TDI, polymethylenepolyphenyl isocyanurate, crude MDI, xylylene diisocyanate (XDI) and phenylene diisocyanate; aliphatic diisocyanates, such as 4,4′-methylene-biscyclohexyl diisocyanate (hydrogenated MDI), hexamethylene diisocyanate (HMDI), isophorone diisocyanate (IPDI) and cyclohexane diisocyanate (hydrogenated XDI); and modified products thereof, such as isocyanurates, carbodiimides, and allophanamides.

Suitable blocking agents for NCO groups include all common compounds which can be eliminated again at temperatures below 200° C., such as methyl ethyl ketoxime, acetone oxime, phenol and phenol derivatives, ε-caprolactam, 1,2,4-triazole, 2,5-dimethylpyrazole, diethyl malonate, ethyl acetoacetate, N-tert-butyl-N-benzylamine, or diisopropylamine.

Non-limiting examples of commercially available blocked polyisocyanates include IMPRAFIX® 2794 from Covestro (an HDI trimer blocked by 3,5-dimethyl pyrazole and further includes N-(2-aminoethyl)-beta-alaninate; acid number of 10 mg KOH/g) and BAYHYDUR® BL XP 2706 from Covestro (blocked aliphatic polyisocyanate, acid number of 32 mg KOH/g) (Covestro AG, Germany). IMPRAFIX® 2794 can be deblocked at about 130° C. Non-limiting examples of commercially available non-ionic blocked polyisocyanates that can be used include Matsui FIXER™ WF-N from Matsui Shikiso Chemical (a 3,5-dimethyl pyrazole non-ionic blocked polyisocyanate) (Matsui Shikiso Chemical, Japan) and TRIXENE® Aqua BI 220 from Baxenden (non-ionic aliphatic water-dispersed blocked isocyanate) (Baxenden Chemicals Limited, United Kingdom). Matsui FIXER™ WF-N can be deblocked at about 150° C. Additional examples of blocked polyisocyanates that can be used include BAYHYDUR® BL 2867, BAYHYDUR® BL 2781, BAYHYDUR® BL 5335, BAYBOND® XL 6366 XP, BAYBOND® XL 825, BAYBOND® XL 7270, BAYBOND® XL 3674 XP, which are from Covestro or VESTANAT® EP-DS 1205 E and VESTANAT® EP-DS 1076 from Evonik (Evonik Industries AG, Germany).

A compound having terminal hydroxyl groups (R—(OH)ₙ), where n is at least 2 (referred to herein as “di-functional”), at least 3 (referred to herein as “tri-functional”), at least 4, at least 5, at least 6, at least 7, at least 8, at least 9, and no greater than 10, where R is an aliphatic and/or cyclic group, is referred to herein as a “polyol.” The skilled person will recognize that a polyol mixture will often include a small amount of mono-functional compounds having a single terminal hydroxyl group.

Examples of polyols include, but are not limited to, polyester polyols and polyether polyols. Examples of polyester polyols include, but are not limited to, those built from condensation of acids and alcohols. Specific examples include those built from phthalic anhydride and di-ethylene glycol, phthalic anhydride, and di-propylene glycol, adipic acid and butane diol, or succinic acid and butane or hexane diol. Examples of polyether polyols include, but are not limited to, those built from polymerization of an oxide such as ethylene oxide, propylene oxide, or butylene oxide from an initiator such as glycerol, di-propylene glycol, TPG (tripropylene glycol), castor oil, sucrose, or sorbitol. Other examples of polyols include, but are not limited to, polycarbonate polyols and lactone polyols such as polycaprolactone. In one embodiment, a compound having terminal hydroxyl groups (R—(OH)ₙ) has a molecular weight (calculated before incorporation of the compound having terminal hydroxyl groups into a polymer) of from 200 Daltons to 20,000 Daltons, such as from 200 Daltons to 10,000 Daltons.

Non-limiting examples of commercially available polyols that can be used include Bayhydrol® A145, A2058, A2227/1, A242, A2427, A2542, A2546, A2601, A2646, A2651, A2695, AXP2770, A2845XP, A2846XP, U241, U355, U475, UXP2750, U2757, UXP2766, UXP7110E, and combinations thereof (Covestro AG, Germany).

The combination of blocked isocyanate and the polyol may further include an additive. Exemplary additives include, but are not limited to, a catalyst, a chain extender, a curing agent, a surfactant, a pigment, a dye, a rheology modifier, and a filler such as an inorganic filler.

For example, suitable catalysts can include amines or organometallic catalysts such as tin compounds, bismuth compounds, zinc compounds, and zirconium compounds. Optionally, a bismuth carboxylate may be a suitable catalyst, for instance bismuth neodecanoate and/or bismuth ethylhexanoate. Suitable amine catalysts include cyclohexyldimethylamine, 2-dimethylaminoethanol, 4-ethylmorpholine, N,N,4-trimethylpiperazine-1-ethylamine, 1,4-dimethylpiperazine, 3-aminopropyldimethylamine, 2,2′-iminodiethanol, 1-methylimidazole, 1,2-dimethylimidazole, 2-[[2-(dimethylamino)ethyl]methylamino]ethanol, N-[3-(dimethylamino)propyl]-N,N′,N′-trimethylpropane-1,3-diamine, formic acid, compound with 2,2′-oxybis[N,N-dimethylethylamine](2:1), 1,1′-[[3-(dimethylamino)propyl]imino]bispropan-2-ol, 2-[(2-[2-(dimethylamino)ethoxy]ethyl)methylamino]ethanol, benzyldimethylamine 4-methylmorpholine, N,N,N′,N′-tetramethylhexamethylenediamine, 2-[2-(dimethylamino)ethoxy]ethanol, 1,4-diazabicyclooctane, bis(2-dimethylaminoethyl) (methyl)amine, N,N,N′,N′-tetramethyl-2,2′-oxybis(ethylamine, 2,2′-dimorpholinyldiethyl ether, 1,8-diazabicyclo[5.4.0]undec-7-ene, N′-[3-(dimethylamino)propyl]-N,N-dimethylpropane-1,3-diamine, N,N,N′,N′,N″,N″-hexamethyl-1,3,5-triazine-1,3,5(2H,4H,6H)-tripropanamine, and N,N-bis[3-(dimethylamino)propyl]-N′,N′-dimethylpropane-1,3-diamine.

Other examples of suitable catalysts include tetramethylammonium formate, tetramethylammonium acetate, tetramethylammonium propionate, tetramethylammonium butyrate, tetramethylammonium benzoate, tetraethylammonium formate, tetraethylammonium acetate, tetraethylammonium propionate, tetraethylammonium butyrate, tetraethylammonium benzoate, tetrapropylammonium formate, tetrapropylammonium acetate, tetrapropylammonium propionate, tetrapropylammonium butyrate, tetrapropylammonium benzoate, tetrabutylammonium formate, tetrabutylammonium acetate, tetrabutylammonium propionate, tetrabutylammonium butyrate and tetrabutylammonium benzoate, methyltributylammonium hydroxide, methyltriethylammonium hydroxide, tetramethylammonium hydroxide, tetraethylammonium hydroxide, tetrapropylammonium hydroxide, tetrabutylammonium hydroxide, tetrapentylammonium hydroxide, tetrahexylammonium hydroxide, tetraoctylammonium hydroxide, tetradecylammonium hydroxide, tetradecyltrihexylammonium hydroxide, tetraoctadecylammonium hydroxide, benzyltrimethylammonium hydroxide, benzyltriethylammonium hydroxide, trimethylphenylammonium hydroxide, triethylmethylammonium hydroxide, trimethylvinylammonium hydroxide, tetramethylammonium fluoride, tetraethylammonium fluoride, tetrabutylammonium fluoride, tetraoctylammonium fluoride, and benzyltrimethylammonium fluoride.

Another aspect provides for an adhesive dispensing system 200. Referring again to FIG. 2, the adhesive dispensing system includes a blocked isocyanate component and a polyol component that are disposed in a heated chamber 210. A heating element 215 is configured to heat the heated chamber 210 at a temperature and for a time that are sufficient to de-block the blocked isocyante component and to form a deblocked isocyanate component. The adhesive dispensing system 200 further includes a dispenser nozzle 240 for receiving the deblocked isocyanate component and the polyol component from the heated chamber 210, wherein the dispenser nozzle 240 is configured to partially react the deblocked isocyanate component and the polyol component therein. An amount of de-blocking of the blocked isocyanate component is determined in the heated chamber 210 using a first detection probe 220 located adjacent to a first end 203 of the heated chamber and a second detection probe 222 located adjacent to a second end 205 of the heated chamber 110.

The heating element 215 may be any suitable type of heater or heating device. For example, the heating element 215 may include one or more resistive heaters, one or more ceramic heaters, or the like. The adhesive dispensing system 200 may include one or more heating elements 215.

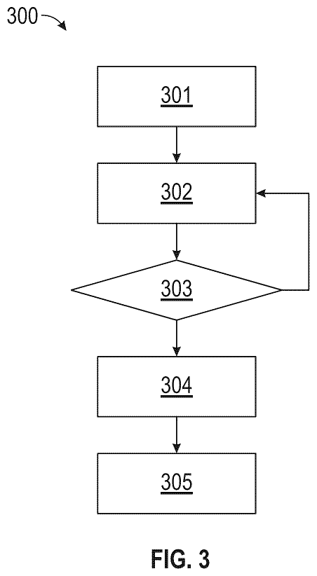

FIG. 3 is a flow diagram 300 illustrating a method for operating the adhesive dispensing system 200 according to one or more embodiments. The flow diagram begins at block 301, where the mixture of a blocked isocyanate component and a polyol component are introduced into the first end 203 of the heated chamber 210. The heated chamber 210 is subsequently heated at block 302 at a temperature and for a time that are sufficient to de-block the blocked isocyanate component to form a deblocked isocyanate component. In block 303, the first detection probe 220 and the second detection probe 222 are used to determine the extent of the deblocking of the blocked isocyanate component. If the blocked isocyanate has not been sufficiently de-blocked, then proceed to block 302 to continue the heating. If the blocked isocyanate has been sufficiently de-blocked, then proceed to block 304 by extruding the deblocked isocyanate component and the polyol component out of a second end 205 of the heated chamber 210 and into a dispenser nozzle 240. The deblocked isocyanate component and the polyol component may be partially reacted in the dispenser nozzle 240 before the deblocked isocyanate component and the polyol component are dispensed from the dispenser nozzle 240 to form the adhesive layer at block 305.

In terms of hardware architecture, the adhesive dispensing system can be implemented in part using a computing device that can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed. The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set), or generally any device for executing software.

The memory can include any one or combination of volatile memory elements (e.g., random access memory (RAM, such as DRAM, SRAM, SDRAM, VRAM, etc.)) and/or nonvolatile memory elements (e.g., ROM, hard drive, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

One should note that FIG. 3 shows an architecture, functionality, and/or operation scheme that can be implemented in part using software. In this regard, one or more of the blocks can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of forming an adhesive layer, the method comprising:
providing a blocked isocyanate component and a polyol component;
introducing the blocked isocyanate component and the polyol component into a first end of a heated chamber;
heating the heated chamber at a temperature and for a time that are sufficient to de-block the blocked isocyanate component to form a deblocked isocyanate component;
extruding the deblocked isocyanate component and the polyol component out of a second end of the heated chamber and into a dispenser nozzle; and
dispensing the deblocked isocyanate component and the polyol component from the dispenser nozzle to form an adhesive layer,
wherein an amount of de-blocking of the blocked isocyanate component is determined in the heated chamber using a first detection probe located adjacent to the first end of the heated chamber and a second detection probe located adjacent to the second end of the heated chamber.

2. The method of claim 1, wherein the heated chamber is heated at a temperature of 60° C. to 200° C.

3. The method of claim 1, wherein the heated chamber is heated for a time of 5 minutes to 4 hours.

4. The method of claim 1, wherein the first detection probe is a Fourier transform infrared spectrometer probe.

5. The method of claim 1, wherein the second detection probe is a Fourier transform infrared spectrometer probe.

6. The method of claim 1, wherein the adhesive layer does not comprise a foam.

7. The method of claim 1, wherein the adhesive layer does not comprise a blowing agent.

8. The method of claim 1, wherein the adhesive layer does not comprise a propellant.

9. The method of claim 1, wherein the heated chamber is heated in a uniform manner.

10. The method of claim 1, wherein a temperature of the dispenser nozzle is less than or equal to the temperature of the heated chamber.

11. An adhesive dispensing system, comprising:
a blocked isocyanate component and a polyol component disposed in a heated chamber;
a heating element configured to heat the heated chamber at a temperature and for a time that are sufficient to de-block the blocked isocyanate component and to form a deblocked isocyanate component; and
a dispenser nozzle for receiving the deblocked isocyanate component and the polyol component from the heated chamber, wherein the dispenser nozzle is configured to dispense the deblocked isocyanate component and the polyol component,
wherein an amount of de-blocking of the blocked isocyanate component is determined in the heated chamber using a first detection probe located adjacent to a first end of the heated chamber and a second detection probe located adjacent to a second end of the heated chamber.

12. The adhesive dispensing system of claim 11, wherein the heated chamber is heated at a temperature of 60° C. to 200° C.

13. The adhesive dispensing system of claim 11, wherein the heated chamber is heated for a time of 5 minutes to 4 hours.

14. The adhesive dispensing system of claim 11, wherein the first detection probe is a Fourier transform infrared spectrometer probe.

15. The adhesive dispensing system of claim 11, wherein the second detection probe is a Fourier transform infrared spectrometer probe.

16. The adhesive dispensing system of claim 11, wherein the adhesive dispensing system does not comprise a foam component.

17. The adhesive dispensing system of claim 11, wherein the adhesive dispensing system does not comprise a blowing agent.

18. The adhesive dispensing system of claim 11, wherein the adhesive dispensing system does not comprise a propellant.

19. The adhesive dispensing system of claim 11, wherein the heated chamber is heated in a uniform manner.

20. The adhesive dispensing system of claim 11, wherein a temperature of the dispenser nozzle is less than or equal to the temperature of the heated chamber.
